(19) United States
(12) Patent Application Publication
(10) Pub. No.: US 2009/0003856 A1
(43) Pub. Date: Jan. 1, 2009

(54) IMAGE FORMING APPARATUS

(75) Inventor: Kunihiko Tanaka, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/140,386

(22) Filed: Jun. 17, 2008

(30) Foreign Application Priority Data
Jun. 28, 2007 (JP) 2007-170786

(51) Int. Cl. G03G 15/00

(52) U.S. Cl. 399/45

(57) ABSTRACT

A complex machine includes an image reading section for reading an image from a document. A determining section determines whether the read image includes a predetermined confidential pattern. A breaking pattern inserting section inserts a breaking pattern to the document image to break the document image. A printing section can print an image onto a recording sheet and a transmitting section can transmit the image read by the image reading section to external equipment. A controller controls the printing section to print a document image, to which the breaking pattern is inserted by the breaking pattern inserting section, if the copy function is executed. However, the controller prohibits the transmission section from transmitting the document image to outside if the facsimile function or the scanner function is executed and if the determining section determines that the image read by the image reading section includes the confidential pattern.

### BACKGROUND OF THE INVENTION

1. Field of the Invention

The present invention relates to an image forming apparatus having a copy function, a scanner function, and a facsimile function. More particularly it relates to a technology of preventing a leakage of a confidential document.

2. Description of the Related Art

Conventionally, it has been required that an image forming apparatus having a copy function, a scanner function, and a facsimile function, a so-called complex machine, adopt a technology of preventing a leakage of confidential information printed on a document. For example, as disclosed in a patent document 1 (Japanese Patent Unexamined Publication No. 2004-274092), there has been proposed a technology according to which an image on a document includes a confidential pattern indicating that the image is confidential information, and an output of the document image is prohibited if a confidential pattern is detected from a document image at a time when the document image is read. Further, there has been proposed in a patent document 2 (Japanese Patent Unexamined Publication No. 2006-173757) a technology of preventing a leakage of information by inserting a breaking pattern, which breaks a content of a document image, into a document image if a confidential pattern is detected from the document image.

However, in order to prohibit output of all document images subjected to be outputted at a time when the confidential pattern is detected, and perform a control of outputting the document images after it is determined that none of these document images includes the confidential pattern, like the technology disclosed in the patent document 1, it is necessary that all of the document images subjected to be outputted are accumulated in a memory temporarily. Therefore, a start timing of outputting is delayed at the time when an output is permitted, and the output cannot be performed in a real-time manner. Accordingly, productivity is lowered. Further, in the case of the technology disclosed in the patent document 2, the insertion of the breaking pattern is performed at the time when the scanner function or the facsimile function is executed. Accordingly, transmission of the document image to which the breaking pattern is inserted may cause confusion on a receiver side, or transmission of unnecessary data may cause a load on a network.

### SUMMARY OF THE INVENTION

The present invention was made in view of this point, and its object is to provide an image forming apparatus having a copy function, a scanner function, and a facsimile function in which lowering of productivity and wasted communication are prevented to a maximum extent while a leakage of information of a confidential image is prevented.

In summary, according to an aspect of the present invention, an image forming apparatus having a copy function, a facsimile function, and a scanner function includes: an image reading section for reading a document image from a document; a determining section for determining whether the document image read by the image reading section includes a predetermined confidential pattern indicating that the document image is a confidential image; a breaking pattern inserting section for inserting a breaking pattern to the document image to break the document image; a printing section for printing an image onto a recording sheet; a transmitting section for transmitting the document image read by the image reading section to an external equipment; and a controller for controlling the printing section to print a document image, to which the breaking pattern is inserted by the breaking pattern inserting section, at a time when the copy function is executed, and prohibiting the transmission section from transmitting the document image to outside at a time when the facsimile function or the scanner function is executed, in a case where the determining section determines that the document image read by the image reading section includes the confidential pattern.

These and other objects, features and advantages of the present invention will become more apparent upon reading of the following detailed description along with the accompanied drawings.

### BRIEF DESCRIPTION OF THE DRAWINGS

FIG. 1 schematically shows a structure of a complex machine.

FIG. 2 is a block diagram showing a detailed configuration of the complex machine.

FIG. 3 is a flowchart showing an operation of the complex machine.

FIG. 4 is a flowchart showing a processing of a copy function executed in the complex machine.

FIG. 5 shows a document image breaking processing executed by a breaking pattern inserting section.

FIG. 6 is a flowchart showing a processing of a scanner function executed in the complex machine.

FIGS. 7A, 7B1a, 7B1b, and 7B2 show results of communications in which the complex machine allows a LAN communication section to perform communication of a plurality of document images at the time when the scanner function is executed.

FIG. 8 is a flowchart showing a processing of the facsimile function executed in the complex machine.

### DETAILED DESCRIPTION OF THE PREFERRED EMBODIMENTS

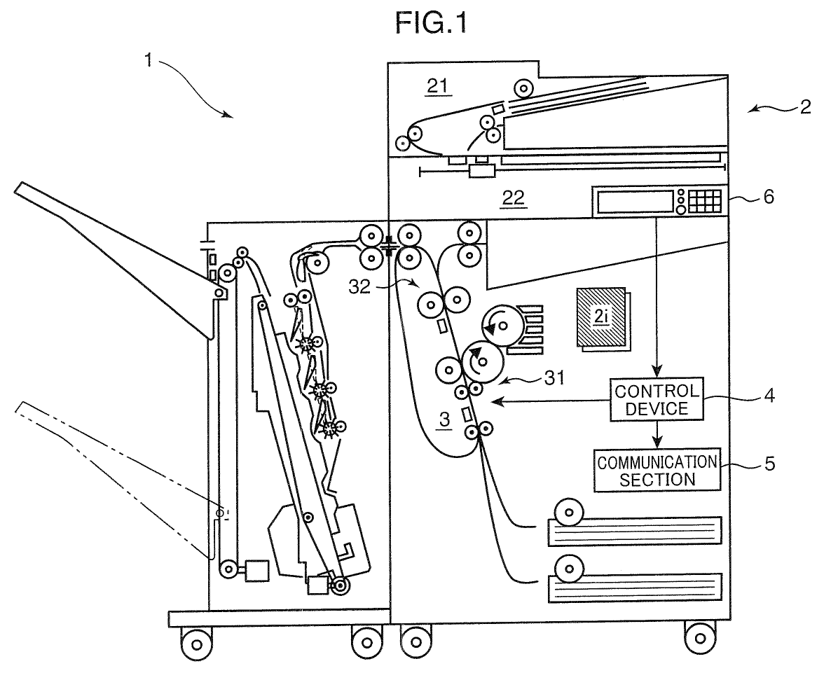

Hereinafter, an image forming apparatus in accordance with an embodiment of the present invention will be described with reference to the drawings. FIG. 1 schematically shows a structure of a complex machine 1 which is an image forming apparatus in accordance with an embodiment of the present invention.

The complex machine 1 is an image forming apparatus having a copy function, a facsimile function, a scanner function, and a printer function. The complex machine 1 includes a document reading section 2, an image forming mechanism 3, a control device 4, a communication section 5, and an operation panel 6. The document reading section 2 is an example of an “image reading section” described in claims. The image forming mechanism 3 is an example of “a printing section.” The communication section 5 is an example of a “communication section.” The operation panel 6 is an example of a “notifying portion.”

The document reading section 2 includes an automatic document feeding unit (Auto Document Feeder) 21 and a scanner unit 22. The automatic document feeding unit 21 sends documents, which are set by an operator, one after another to the scanner unit 22. The scanner unit 22 reads images of the documents sent by the automatic document feeding unit 21 and transmits the read document images to the control device 4 at each time when one sheet of document is read.

The image forming mechanism 3 includes an image forming section 31 and a fixing section 32. The image forming section 31 has a photoconductive drum which forms an image onto a recording sheet which is conveyed to a conveying passage conveying recording sheets stacked on a sheet feeding cassette. The fixing section 32 heats the recording sheet bearing an image to fix an image formed by the image forming section onto a recording sheet.

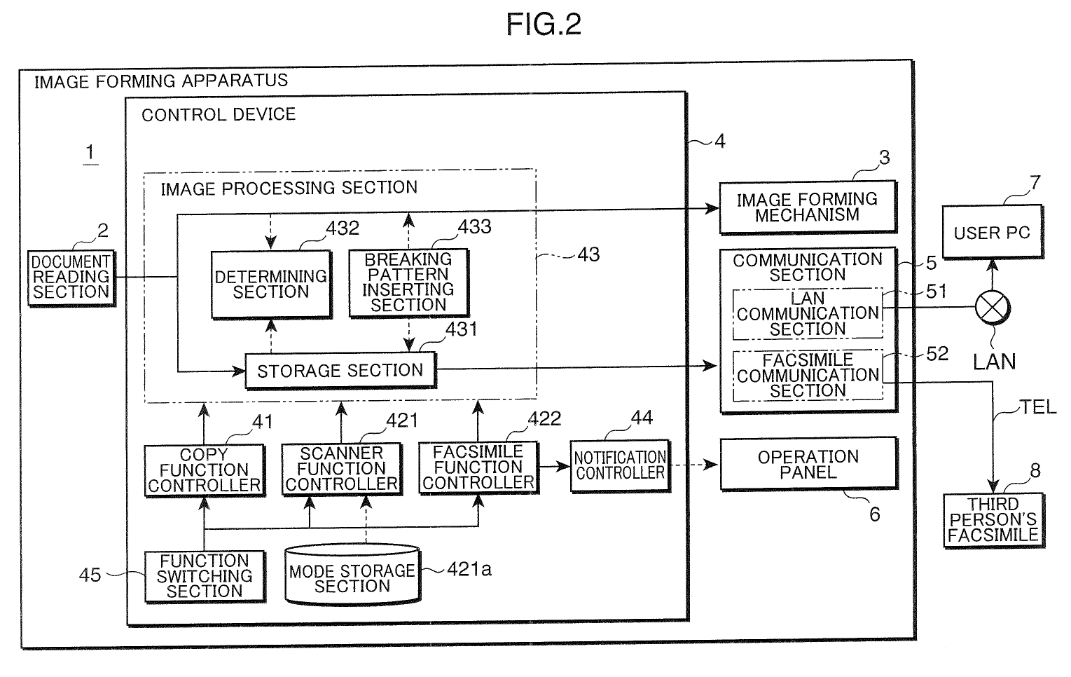

FIG. 2 is a block diagram showing a detailed configuration of the complex machine 1. The communication section 5 is a communication device which communicates with a personal computer (hereinafter, referred to as PC) 7, which is connected with the complex machine 1 via a network, or a facsimile machine 8 via a public line. The communication section 5 includes a LAN communication section 51 and a facsimile communication section 52.

The LAN communication section 51 has a function for communicating with the PC7 connected to the complex machine 1 via a network such as a LAN. The facsimile communication section 52 has a function for performing a facsimile communication with the external facsimile machine 8 via a public line. The facsimile communication section 52 performs a facsimile transmission by using a transmission method in accordance with a standard such as a G4 standard for a facsimile communication.

The operation panel 6 includes a liquid crystal display portion and a touch panel provided on the liquid crystal display portion. The operation panel 6 receives an input of an instruction from an operator based on an operation performed by an operator, and displays an operation guide information for an operator.

The control device (controller) 4 is, for example, an information processing device including a computer so configured by using various methods such as a stored program method and a wired logic method, and is adapted to control operations of parts of the complex machine 1.

The control device 4 includes a copy function controller 41, a scanner function controller 421, a mode storage section 421a, a facsimile function controller 422, an image processing section 43, an notification controller 44, and a function switching section 45.

The copy function controller 41, the scanner function controller 421, the facsimile function controller 422, and the notification controller 44 are examples of a “controller” within the claim. The mode storage section 421a is an example of a “mode storage section” within the claim. Further, a determining section 432, a breaking pattern inserting section 433, and a storage section 431 are examples of a “determining section,” a “breaking pattern inserting section,” and a “storage section” respectively within the claim.

The copy function controller 41 controls operations of parts of the complex machine 1 when the copy function is executed. The copy function controller 41 controls the image forming mechanism 3 to print a document image, which is read by the document reading section 2 and processed by the image processing section 43, onto a recording sheet.

The scanner function controller 421 controls operations of parts of the complex machine 1 when the scanner function is executed. The scanner function controller 421 controls the LAN communication section 51 of the communication section 5 to transmit a document image, which is read by the document reading section 2 and processed by the image processing section 43, to the PC 7.

The facsimile function controller 422 controls operations of parts of the complex machine 1 when the facsimile function is executed. The facsimile function controller 422 controls the facsimile communication section 52 of the communication section 5 to transmit a document image, which is read by the document reading section 2 and processed by the image processing section 43, to the facsimile machine 8.

The image processing section 43 performs various image processings, e.g. feathering, edge-emphasizing, edge-extraction, a noise processing with use of expansion processing or reduction processing, and mosaic processing, for improving an image quality with respect to the document image read by the document reading section 2. Further, the image processing section 43 includes a storage section 431, a determining section 432, and a breaking pattern inserting section 433.

The storage section 431 temporarily stores the document image read by the document reading section 2. For example, the storage section 431 includes a RAM, an HDD, and a flash memory.

The determining section 432 determines whether a document image inputted to the image processing section 43 is an image including a confidential pattern. The confidential pattern is a latent image embedded in an image formed on a document. For example, different kinds of dither patterns are used respectively for a latent image portion as a confidential pattern and a background portion other than the latent image portion, and one pattern density is set to be greater than a resolution acquired at a time when a document is read in the image forming apparatus, and the other pattern density is set to be equal to or lower than the resolution acquired at the time when a document is read in the image forming apparatus. At this time, a density difference between the pattern densities is so set that it is difficult for a person to visually confirm the confidential pattern by looking at an original document but the confidential pattern is distinguished when the document is optically read by a scanner or the like of the image forming apparatus. Accordingly, the confidential pattern is detected by reading the document with a scanner. The determining section 432 determines whether image data of the read document image includes data of an image pattern matching with a predetermined confidential pattern. When data of an image pattern matching with the confidential pattern is included, the determining section 432 determines that the document image includes the confidential pattern.

The breaking pattern inserting section 433 inserts a predetermined breaking pattern into a document image. The breaking pattern is a predetermined image (a black solid image, or an abstract image having no meaning). The breaking pattern inserting section 433 replaces the document image with an image presented by the breaking pattern to change the document image to a content which is different from a previous content, so that the document image is broken.

The notification controller 44 is adapted to allow the operation panel 6 to notify an alarm to an operator.

The mode storage section 421a stores transmission methods for transmitting a document image. The transmission methods include first through third modes which are selectively executed in accordance with whether the document image includes a confidential pattern at a time when the scanner function is executed. The mode storage section 421a includes a first mode of controlling the LAN communication section 51 not to transmit a document image, a second mode of controlling the LAN communication section 51 to transmit only a document image which does not include a confidential pattern among document images subjected to be transmitted, and a third mode of inserting a breaking pattern into a document image which includes a confidential pattern and controlling the LAN communication section 51 to transmit the document image.

The function switching section 45 switches which one of the copy function controller 41, the scanner function controller 421, and the facsimile function controller 422 controls parts of the complex machine 1 in accordance with which one of the copy function, the scanner function, and the facsimile function an instruction inputted by an operator to the operation panel 6 relates to.

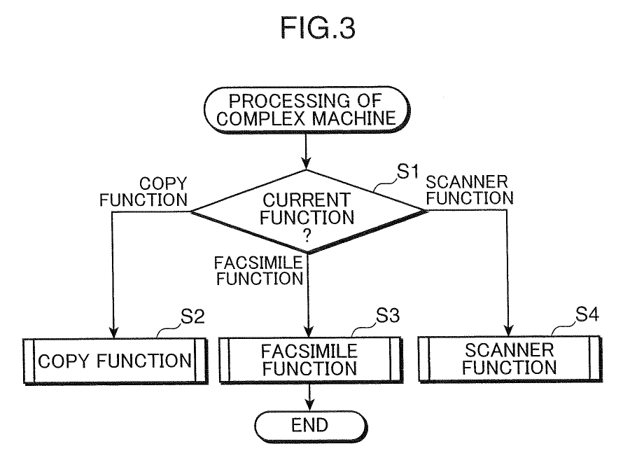

Next, an operation will be described which is performed in the complex machine 1 at a time when any one of the functions is executed. FIG. 3 is a flowchart showing an operation of the complex machine 1. The function switching section 45 of the control device 4 switches which one of the copy function controller 41, the scanner function controller 421, and the facsimile function controller 422 controls parts of the complex machine 1 in accordance with which one of the copy function, the scanner function, and the facsimile function an instruction inputted by an operator to the operation panel 6 relates to (S1).

In other words, when an instruction inputted by an operator to the operation panel 6 relates to the copy function (“COPY FUNCTION” in S1), the copy function controller 41 controls operations of parts of the complex machine 1 to execute the copy function (S2). When an instruction inputted by an operator to the operation panel 6 relates to the facsimile function (“FACSIMILE FUNCTION” in S1), the facsimile function controller 422 controls parts of the complex machine 1 to execute the facsimile function (S3). When an instruction inputted by an operator to the operation panel 6 relates to the scanner function (“SCANNER FUNCTION” in S1), the scanner function controller 421 controls operations of parts of the complex machine 1 to execute the scanner function (S4).

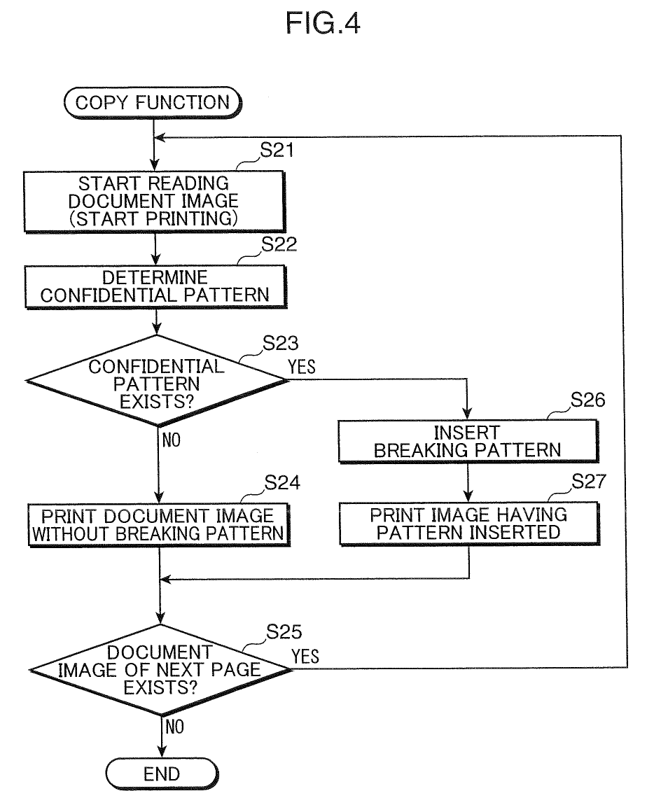

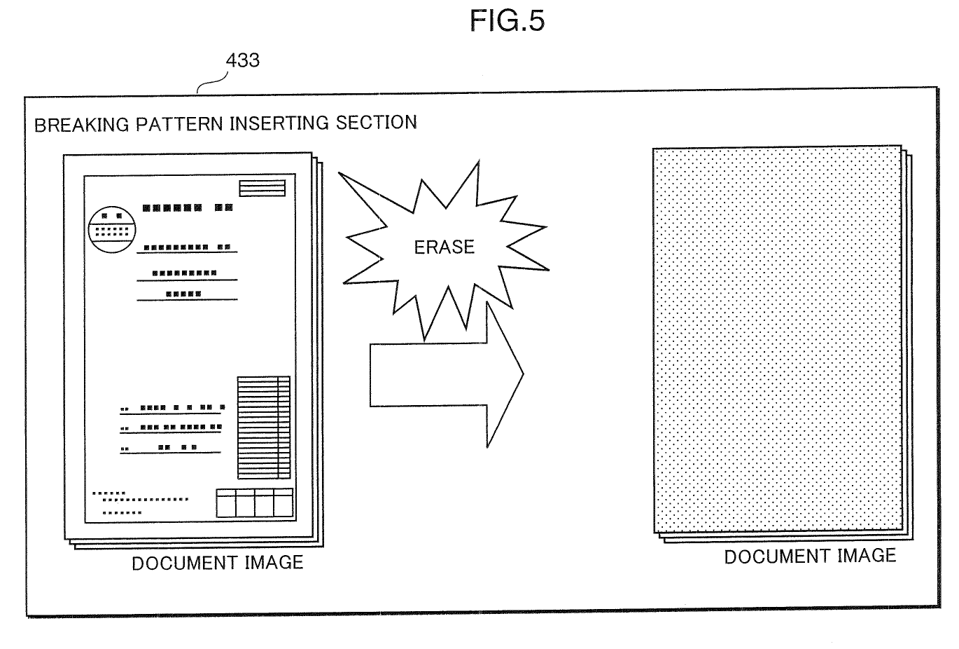

FIG. 4 is a flowchart showing a processing of the copying function executed in the complex machine 1. FIG. 5 shows a document image breaking processing executed by the breaking pattern inserting section.

When the copy function is executed, the copy function controller 41 controls the document reading section 2 so that a scanner unit 22 reads a first sheet of documents set on an automatic document feeding unit 21 (S21). A document image of the first sheet of the read document is temporarily stored in an unillustrated memory in the control device 4.

After the first sheet of the documents is read, the determining section 432 determines whether the document image of the read document includes a confidential pattern (S22).

When the determining section 432 determines that the document image of the read document does not include the confidential pattern (NO in S23), the breaking pattern inserting section 433 does not insert the breaking pattern into the document image, and the copy function controller 41 controls the image forming mechanism 3 to print the document image without modification (S24).

On the other hand, when the determining section 432 determines that the document image of the read document includes the confidential pattern (YES in S23), the breaking pattern inserting section 433 inserts the breaking pattern to the document image (S26). In other words, as shown in FIG. 5, the breaking pattern inserting section 433 replaces the document image with the image presented by the breaking pattern. After that, the copy function controller 41 controls the image forming mechanism 3 to print the image replaced with the breaking pattern (S27).

After the processing of S24 or S27 is executed, the copy function controller 41 determines whether a document remains on the document reading section 2 in accordance with a signal from a document detection sensor provided in the document reading section 2. When a document remains on the document reading section 2 (YES in S25), the routine goes back to the processing of S21. In this case, a document image of the next document is written over the document previously stored in the memory. Further, when a document does not remain on the document reading section 2 (NO in S25), the processing is terminated.

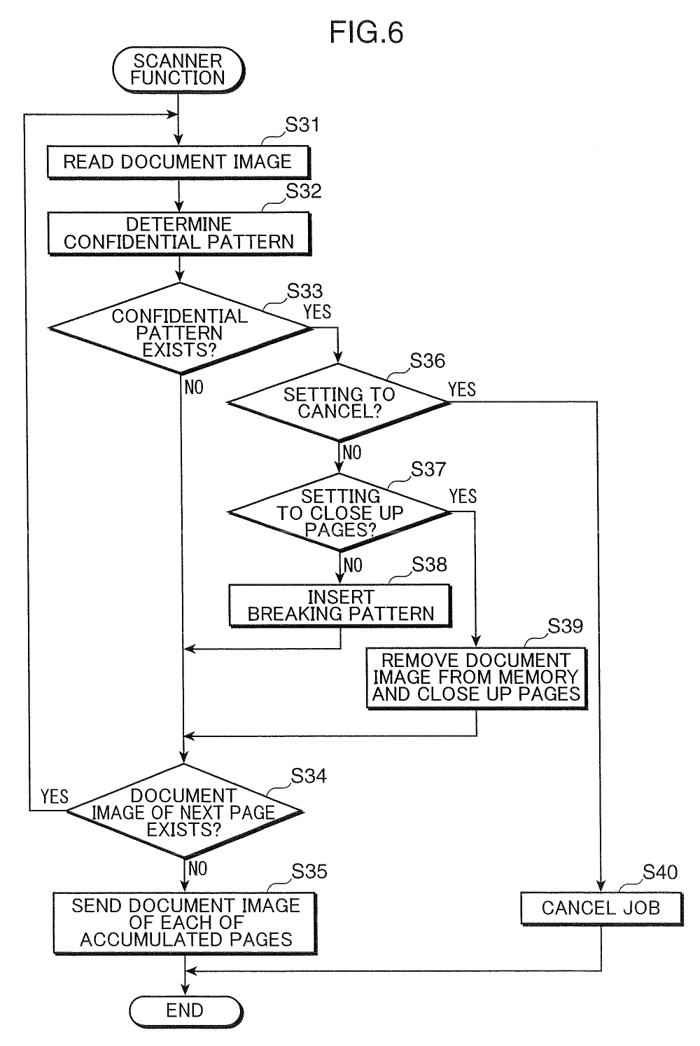

FIG. 6 is a flowchart showing a processing of the scanner function executed in the complex machine 1. When the scanner function is executed, the scanner function controller 421 controls the document reading section 2 so that the scanner unit 22 reads a first sheet of documents set on the automatic document feeding unit 21 (S31). A document image of the first sheet of the read document is accumulated in an unillustrated memory of the control device 4.

After the first sheet of documents is read, and the determining section 432 determines that the document image of the read document does not include the confidential pattern (S32, NO in S33), the scanner function controller 421 allows the routine to go back to the processing of S3 1, and controls the document reading section 2 to read the next document if a document remains on the document reading section 2 (YES in S34).

On the other hand, when the determining section 432 determines that the document image of the read document includes the confidential pattern (S32, YES in S33), the scanner function controller 421 determines which of the above-described first through third modes stored in the mode storage section 421a is to be executed in accordance with a content of an instruction inputted by an operator to the operation panel 6 (S36, S37). Regarding the instruction inputted by an operator, (1) when the determining section 432 determines that a document image of the read document includes the confidential pattern, the scanner function controller 421 may control a liquid crystal display portion of the operation panel 6 to present a message for urging an operator to input an instruction of selecting one of the first through third modes, and the scanner function controller 421 may determine which one of the first through third modes is to be executed in accordance with the instruction inputted by the operator to the operation panel 6 after the message is displayed. (2) Alternatively, the scanner function controller 421 may receive the input of the instruction of selecting one of the first through third modes from the operator in advance and store the same in the mode storage section 421a, and when the determining section 432 determines that the document image of the read document includes the confidential pattern, it may be determined which of the first through third modes is to be executed in accordance with the instruction stored in the mode storage section 421a.

When the instruction inputted by the operator is the first mode, in other words, when the instruction indicates the mode of controlling the LAN communication section 51 not to transmit a document image (YES in S36), the scanner function controller 421 cancels a job of executing the scanner function (S40). In other words, at a point of time when the determining section 432 determines that the document image of the read document includes the confidential pattern, the scanner function controller 421 cancels the job of executing the scanner function and aborts the document reading operation. Then, the scanner function controller 42 terminates the processing without controlling the LAN communication section 51 to transmit all pages of the document images accumulated in the memory.

Further, when the instruction inputted by the operator is the second mode, in other words, when the instruction indicates that the mode of controlling the LAN communication section 51 to transmit only a document image which does not include the confidential pattern among document images subjected to transmission (NO in S36, YES in S37), the scanner function controller 421 erases the document image including the confidential pattern from the storage section 431 (S39). In this case, the scanner function controller 421 retains document images which are read prior to the reading of the document image and accumulated in the memory. Further, going back to the processing S31, when the next document image is read, the scanner function controller 421 accumulates the document images to the memory under the condition that the confidential pattern is not included. After the processing of S39 is executed, the routine goes to S34.

Further, when the instruction inputted by the operator is the third mode, in other words, when the instruction indicates execution of the mode of inserting the breaking pattern into the document image which includes the confidential pattern and controlling the LAN communication section 51 to transmit the same (NO in S37), the breaking pattern inserting section 433 inserts an image including the breaking pattern to the document image including the confidential pattern, and replaces the document image including the confidential pattern with the image including the breaking pattern (S38). In this case, the scanner function controller 421 retains the document image read before the document image and already accumulated in the memory without modification, and replaces only the document image including the confidential pattern with the image including the breaking pattern. Further, going back to the processing of S31, when the next document image is read, the scanner function controller 421 accumulates the read document image to the memory under the condition that the confidential pattern is not included. After the processing of S39 is executed, the routine goes to the processing of S34.

After the processing of NO in S33, the processing of S38, or the processing of S39 is executed, and when a document remains on the document reading section 2 (YES in S34), the scanner function controller 421 allows the routine to go back to the processing of S31. On the other hand, when a document does not remain on the document reading section 2 (NO in S34), the scanner function controller 421 controls the LAN communication section 51 to transmit all of the document images stored in the storage section 431 to the PC 7 (S35). After the transmission, the scanner function controller 421 erases all of the document image data accumulated in the memory.

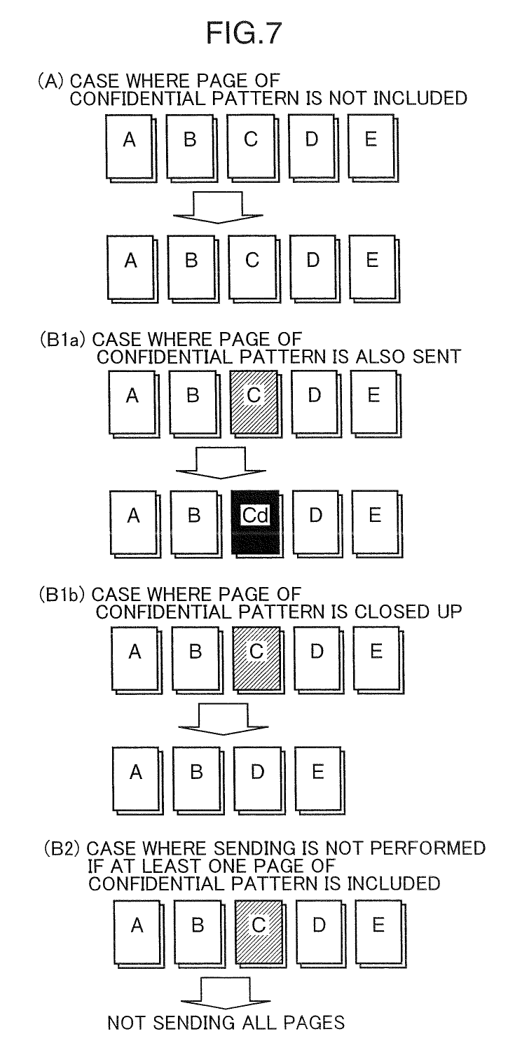

The processing of S35 will be described in detail. FIGS. 7A, 7B1a, 7B1b, and 7B2 show results of communications in which the complex machine 1 allows the LAN communication section 51 to perform communication of a plurality of document images A through E at the time when the scanner function is executed.

In each of FIGS. 7A, 7B1a, 7B1b, and 7B2, document images A through E of five documents to be read by the document reading section 2 are shown in an upper portion. Further, document images, among the five document images A through E, which are communicated by the LAN communication section 51 under a control of the complex machine 1 are shown in a lower portion.

When none of the document images A through E read by the document reading section 2 includes the confidential pattern, all of the document images proceeds to the processing of S34 according to the determination of S33 of FIG. 6 at the time when the document images are read. Accordingly, as shown in the lower portion of FIG. 7A, the scanner function controller 421 controls the LAN communication section 51 to transmit the document images, corresponding to all of the five document images A through E read by the document reading section 2, in an upper portion directly to the personal computer 7.

Further, when any of the document images A through E read by the document reading section 2 includes the confidential pattern, and the instruction inputted by the operator is the first mode, in other words, when the transmission of the document images by the LAN communication section 51 is not performed (YES in S36), and if the document image C, for example, includes the confidential pattern, the scanner function controller 421 controls the document reading section 2 to abort the document reading operation. Further, the scanner function controller 421 controls the LAN communication section 51 not to transmit all of the document images A, B, and C already accumulated in the memory at this point of time, as shown in FIG. 7B2.

Further, when any of the document images A through E read by the document reading section 2 includes the confidential pattern, and the instruction inputted by the operator is the second mode, in other words, when the instruction indicates the mode in which the LAN communication section 51 transmits only the document image which does not include the confidential pattern among the document images to be transmitted (NO in S36, YES in S37), and if the image C, for example, includes the confidential pattern, the scanner function controller 421 erases the document image including the confidential pattern from the storage section 431 (S39), and retains the document images A and B accumulated in the memory at this point of time. Then, after that, the scanner function controller 421 accumulates also the document images D and E not including the confidential pattern into the memory. At a point of time when the document image E is accumulated in the memory, the scanner function controller 421 controls the LAN communication section 51 to transmit the accumulated document images A, B, D, and E to the personal computer 7. In other words, in this case, document image data from which the document image C including the confidential pattern is erased and in which pages of the document images A, B, D, and E are closed up are to be subjected to be transmitted by the LAN communication section 51, as shown in FIG. 7B1b.

Further, when any of the document images A through E read by the document reading section 2 includes the confidential pattern, and the instruction inputted by an operator is the third mode, and execution of the mode of controlling the LAN communication section 51 to transmit a document image which is formed by inserting a breaking pattern to the document image including the confidential pattern is indicated (NO in S37), if the confidential pattern is included in, for example, the document image C, the breaking pattern inserting section 433 inserts the breaking pattern to the document image C to replace the document image including the confidential pattern with the image including the breaking pattern (S38). As shown in FIG. 7B1a, the scanner function controller 421 controls the LAN communication section 51 to transmit the document images A, B, D, and E, which are constituted by read images accumulated in the memory and the document image Cd replaced with the image including the breaking pattern to the personal computer 7 at a point of time when reading of all of the document images A through E is completed.

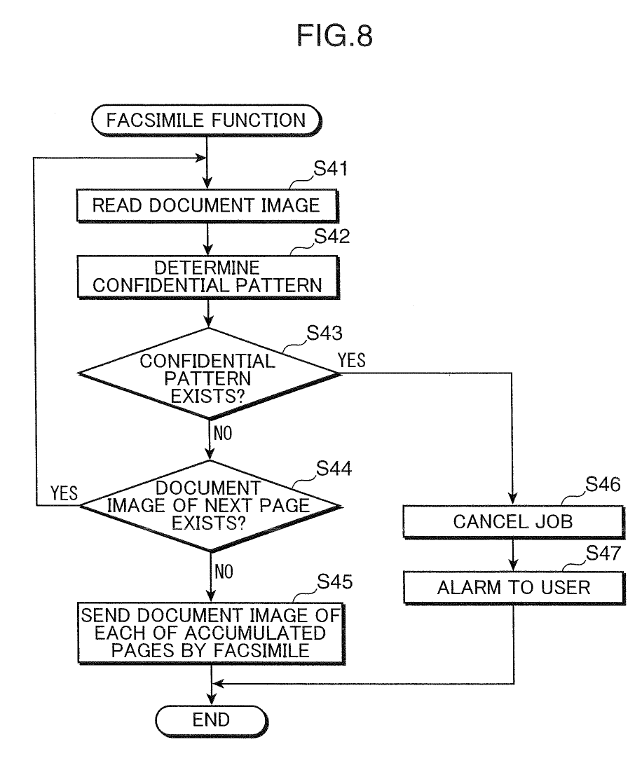

FIG. 8 is a flowchart showing a processing of the facsimile function executed in the complex machine 1. When the facsimile function is execute, the facsimile function controller 422 controls the document reading section 2 so that the scanner unit 22 reads the first sheet of documents set in the automatic document feeding unit 21 (S41). A document image of the first sheet of the read document is accumulated in an unillustrated memory in the control device 4.

After the first sheet of the document is read, when the determining section 432 determines that the document image of the read document does not include the confidential pattern (S42, NO in S43), and a document remains on the document reading section 2 (YES in S44), the facsimile function controller 422 allows the routine to go back to the processing of S41, and then controls the document reading section 2 to read the next document.

When a document does not remain on the document reading section 2 (NO in S44), the facsimile function controller 422 controls the facsimile communication section 52 to transmit all of the document images stored in the storage section 431 to the receiver's facsimile machine 8 (S45).

On the other hand, when the determining section 432 determines that the document image of the document includes the confidential pattern (S42, YES in S43), the facsimile function controller 422 cancels a job of executing the facsimile function (S46). Then, the notification controller 44 controls the liquid crystal display portion of the operation panel 6 to display a massage indicating that the document image read by the document reading section 2 is not to be transmitted to a receiver's facsimile machine (S47). After the processing of S47 is executed, the facsimile function controller 422 terminates the processing.

The present invention is not limited to the configuration of the embodiment, and various modifications may be possible. For example, when a plurality of PCs 7 are connected to the complex machine 1, the scanner function controller 421 may selectively execute any one of the first through third modes in accordance with a receiver of a document image. In this case, the first through third modes are associated respectively to the receivers and stored in the mode storage section 421a. When the scanner function is executed, and the determining section 432 determines that the document image of the read document includes the confidential pattern (S32, YES in S33), the scanner function controller 421 reads the mode associated with the receiver designated by the operation performed by the operator to the operation panel 6 from the mode storage section 421 a so that any one of the first through third modes is executed. Accordingly, methods of transmitting image data can be switched in accordance with an addressee of the image data at the time of scanner transmission (for example, an addressee can manage if a page-omitted document image or a document image having a broken image is sent, or it is not rude to send such images to the addressee).

The configuration and the processing according to the embodiment shown in FIGS. 1 through 8 are a mere example of the configuration and the processing of the image forming apparatus according to the present invention, and it does not limit the configuration and the processing according to the present invention to the one described above.

In summary, an image forming apparatus according to an aspect of the present invention has a copy function, a facsimile function, and a scanner function, and includes: an image reading section for reading a document image from a document; a determining section for determining whether the document image read by the image reading section includes a predetermined confidential pattern indicating that the document image is a confidential image; a breaking pattern inserting section for inserting a breaking pattern to the document image to break the document image; a printing section for printing an image onto a recording sheet; a transmitting section for transmitting the document image read by the image reading section to an external equipment; and a controller for controlling the printing section to print a document image, to which the breaking pattern is inserted by the breaking pattern inserting section, at a time when the copy function is executed, and prohibiting the transmission section from transmitting the document image to outside at a time when the facsimile function or the scanner function is executed, in a case where the determining section determines that the document image read by the image reading section includes the confidential pattern.

According to the invention, when a copy function is executed, and the determining section determines that a document image the confidential pattern, the controller performs a control of printing a document image to which a breaking pattern is inserted. Accordingly, without terminating accumulation of all of document images subjected to printing into the memory, printing of the read document image or printing of a document image to which the breaking pattern is inserted is possible at each time when each document image is read by the image reading device. Therefore, the leakage of information of the confidential image can be prevented. Further, since a delay in printing timing does not occur, lowering in productivity can be prevented. Further, at a time when the facsimile function or the scanner function is executed, and the determining section determines that the document image includes a confidential pattern, the controller does not allow the transmitting device to transmit the document image to outside. Accordingly, the leakage of information of the confidential image can be prevented, and wasteful communication of transmitting an image including a breaking pattern to an addressee can be eliminated.

In other words, according to the present invention, an image forming apparatus having a copy function, a scanner function, and a facsimile function performs different controls in accordance with a function to be executed. Accordingly, the leakage of information of a confidential image can be prevented, and lowering of productivity or wasteful communication can be prevented at maximum.

Further, according to the present invention, it is preferable that the image reading section reads respective document images of a plurality of pages of documents, and the image forming apparatus further comprises a storage section for storing the document images, and at the time when the facsimile function or the scanner function is executed, the controller allows the document images read by the image reading section to be accumulated in the storage section, and controls the communication section to transmit all of the document images accumulated in the storage section after the determining section determines that a confidential pattern included in none of the document images.

According to this invention, at a time when the facsimile function or the scanner function is executed, the controller can perform controls of allowing the communication unit to communicate or prohibiting the communication regarding all of the document image stored in the storage device in accordance with a result of determination of whether each document image includes a confidential pattern. Accordingly, transmission of the document image including the confidential pattern can be prohibited to prevent the information leakage, and a document image including the breaking pattern is not transmitted to an addressee.

Further, according to the present invention, it is preferable that the image reading section reads respective document images of a plurality of pages of documents, and the image forming apparatus further comprises a storage section for storing the document images, and at the time when the scanner function is executed, the controller allows the document images read by the image reading section to be accumulated in the storage section, and controls the communication section to transmit only a document image of a page which is determined by the determining section as not including the confidential pattern.

At a time of execution of the scanner function, it is more likely that an addressee of the document image is a personal computer of an operator or a personal computer of a person who is close to the operator. Accordingly, even if a plurality of pages of data including a document image other than a document image including a breaking pattern (in other words, a plurality of pages of data from which a page is omitted), it is less likely to cause a harmful effect to a receiver of the document image. Therefore, according to the present invention, the controller controls a transmitting device to transmit only a document image including no confidential pattern. Therefore, leakage of confidential information is prevented, and convenience for a user is secured so that productivity is not lowered.

Further, according to the present invention, it is preferable that the image reading section reads respective document images of a plurality of pages of documents, and the image forming apparatus further comprises a storage section for storing the document images, and at the time when the facsimile function is executed, the controller allows the document images read by the image reading section to be accumulated in the storage section, and cancels a facsimile function execution job at a point of time when the determining section determines that the confidential pattern is included.

At a time of execution of the facsimile function, it is not always true that an addressee of the document image is a person who is close to an operator. Accordingly, a plurality of pages of data including a document image other than a document image including a breaking pattern (in other words, a plurality of pages of data from which a page is omitted), it is likely to cause a harmful effect to a receiver of the document image. Therefore, according to the present invention, the controller cancels a job of executing the facsimile function and prevents previously read document images from being sent via facsimile at a point of time when a document image including a confidential pattern is found, so that the leakage of confidential information can be prevented, and a convenience for a user is secured.

Further, according to the present invention, it is preferable that an image forming apparatus further comprises: a mode storage section for storing a first mode of prohibiting the transmitting section from transmitting a document image, a second mode of allowing the transmitting section to transmit only a document image not including the confidential pattern among document images to be transmitted, and a third mode of inserting the breaking pattern into a document image including the confidential pattern and controlling the transmitting section to transmit document images; and an instruction inputting section for allowing an operator to input an instruction regarding selection of the modes stored in the mode storage section. When the determining section determines that the document image read by the image reading section includes the confidential pattern at the time when the scanner function is executed, the controller executes a mode, among the first through third modes stored in the mode storage section, indicated by an instruction inputted to the instruction inputting section.

At a time of execution of the scanner function, it is more likely that an addressee of the document image is a personal computer of an operator or a personal computer of a person who is close to the operator. Accordingly, even if a plurality of pages of data including a document image other than a document image including a breaking pattern (in other words, a plurality of pages of data from which a page is omitted), it is less likely to cause a harmful effect to a receiver of the document image. In this case, in accordance with a selection by an operator, the controller selectively executes one of a first mode of not allowing a transmitting device to transmit a document image, a second mode of allowing the transmitting device to transmit only a document image including no confidential pattern among document images subjected to transmission, and a third mode of allowing the transmitting device to transmit a document image which is formed by inserting a breaking pattern with respect to a document image including a confidential pattern. Accordingly, a convenience for an operator in handling a document image can be improved.

Further, according to the present invention, it is preferable that the image forming apparatus further comprises a notifying portion for notifying a warning to an operator. When the determining section determines that a document image read by the image reading section includes the confidential pattern at the time when the facsimile function is executed, the controller controls the notifying portion to notify the warning.

According to the present invention, when a document image includes a confidential pattern at a time of execution of the facsimile function, an operator is notified that a document image which should be transmitted to an addressee is not to be transmitted.

This application is based on Japanese Patent application serial No. 2007-170786 filed in Japan Patent Office on Jun. 28, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus having a copy function, a facsimile function, and a scanner function, the image forming apparatus comprising:
an image reading section for reading a document image from a document;
a determining section for determining whether the document image read by the image reading section includes a predetermined confidential pattern indicating that the document image is a confidential image;
a breaking pattern inserting section for inserting a breaking pattern to the document image to break the document image;
a printing section for printing an image onto a recording sheet;
a transmitting section for transmitting the document image read by the image reading section to an external equipment; and
a controller for controlling the printing section to print a document image, to which the breaking pattern is inserted by the breaking pattern inserting section, at a time when the copy function is executed, and prohibiting the transmission section from transmitting the document image to outside at a time when the facsimile function or the scanner function is executed, in a case where the determining section determines that the document image read by the image reading section includes the confidential pattern.

2. The image forming apparatus according to claim 1, wherein:
the image reading section reads respective document images of a plurality of pages of documents, and
the image forming apparatus further comprises a storage section for storing the document images, and
at the time when the facsimile function or the scanner function is executed, the controller allows the document images read by the image reading section to be accumulated in the storage section, and controls the communication section to transmit all of the document images accumulated in the storage section after the determining section determines that a confidential pattern is included in none of the document images.

3. The image forming apparatus according to claim 1, wherein:
the image reading section reads respective document images of a plurality of pages of documents, and
the image forming apparatus further comprises a storage section for storing the document images, and
at the time when the scanner function is executed, the controller allows the document images read by the image reading section to be accumulated in the storage section, and controls the communication section to transmit only a document image of a page which is determined by the determining section as not including the confidential pattern.

4. The image forming apparatus according to claim 1, wherein:
the image reading section reads respective document images of a plurality of pages of documents, and
the image forming apparatus further comprises a storage section for storing the document images, and
at the time when the facsimile function is executed, the controller allows the document images read by the image reading section to be accumulated in the storage section, and cancels a facsimile function execution job at a point of time when the determining section determines that the confidential pattern is included.

5. The image forming apparatus according to claim 1, further comprising:
a mode storage section for storing a first mode of prohibiting the transmitting section from transmitting a document image, a second mode of allowing the transmitting section to transmit only a document image not including the confidential pattern among document images to be transmitted, and a third mode of inserting the breaking pattern into a document image including the confidential pattern and controlling the transmitting section to transmit document images; and
an instruction inputting section for allowing an operator to input an instruction regarding selection of the modes stored in the mode storage section, wherein
when the determining section determines that the document image read by the image reading section includes the confidential pattern at the time when the scanner function is executed, the controller executes a mode, among the first through third modes stored in the mode storage section, indicated by an instruction inputted to the instruction inputting section.

6. The image forming apparatus according to claim 2, further comprising:
a mode storage section for storing a first mode of prohibiting the transmitting section from transmitting a document image, a second mode of allowing the transmitting section to transmit only a document image not including the confidential pattern among document images to be transmitted, and a third mode of inserting the breaking pattern into a document image including the confidential pattern and controlling the transmitting section to transmit document images; and
an instruction inputting section for allowing an operator to input an instruction regarding selection of the modes stored in the mode storage section, wherein
when the determining section determines that the document image read by the image reading section includes the confidential pattern at the time when the scanner function is executed, the controller executes a mode, among the first through third modes stored in the mode storage section, indicated by an instruction inputted to the instruction inputting section.

7. The image forming apparatus according to claim 1, further comprising a notifying portion for notifying a warning to an operator, wherein
when the determining section determines that a document image read by the image reading section includes the confidential pattern at the time when the facsimile function is executed, the controller controls the notifying portion to notify the warning.
